(19) United States
(12) Patent Application Publication
(10) Pub. No.: US 2013/0268708 A1
(43) Pub. Date: Oct. 10, 2013

(54) MOTHERBOARD TEST DEVICE AND CONNECTION MODULE THEREOF

(71) Applicants: FENG-CHIEH HUANG, Tu-Cheng (TW); KANG WU, Shenzhen City (CN); GUO-YI CHEN, Shenzhen City (CN)

(72) Inventors: FENG-CHIEH HUANG, Tu-Cheng (TW); KANG WU, Shenzhen City (CN); GUO-YI CHEN, Shenzhen City (CN)

(21) Appl. No.: 13/646,823

(22) Filed: Oct. 8, 2012

(30) Foreign Application Priority Data
Apr. 9, 2012 (CN) 201210100795.4

(51) Int. Cl. G06F 13/00

(52) U.S. Cl. 710/301

(57) ABSTRACT

A motherboard test device includes a motherboard and a connection module. The motherboard includes a basic input output system (BIOS) chip, a complex programmable logic device (CPLD) chip, and a motherboard connector. The connection module includes a test connector connected to the motherboard connector, a first port connected to random access memory (RAM) of the BIOS chip, and a second port connected to the CPLD chip. A RAM simulator updates or tests BIOS programs stored in the RAM by connecting to the first port. A personal computer (PC) can electronically communicate with the CPLD chip by connecting a parallel interface of the PC to the second port.

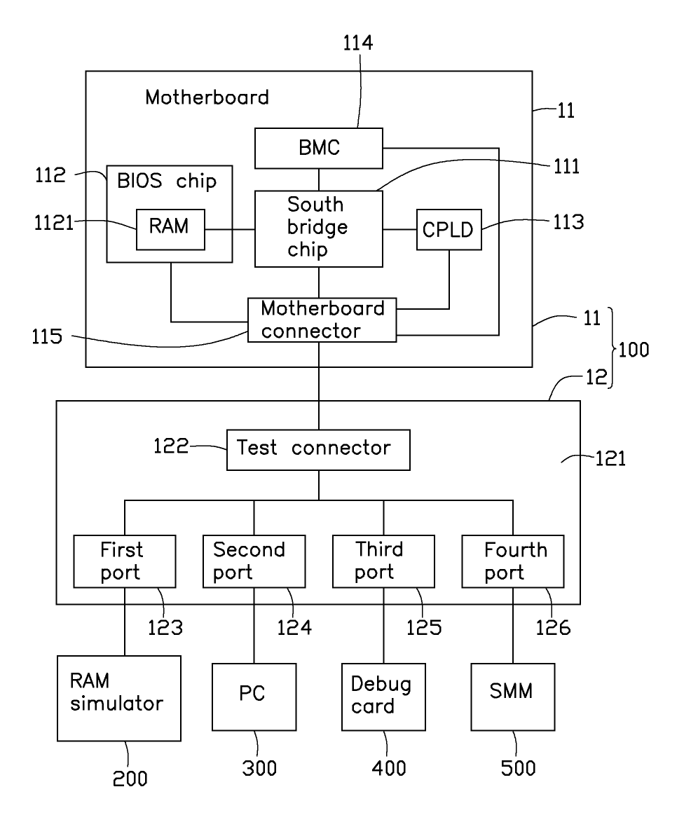

### BACKGROUND

1. Technical Field

The disclosure generally relates to server motherboards or personal computer motherboards, and particularly to a motherboard testing device and a connection module for the motherboard connection.

2. Description of the Related Art

When designing motherboards, such as server motherboards or personal computer motherboards, one or more modules secured on the motherboard need to be tested. When testing, a plurality of test ports are set on the motherboard and are connectable to a plurality of external test devices. In this way, an external test device can output a hardware testing signal or a software update program to the corresponding module through the test port, thereby testing the corresponding module. However, the plurality of test ports will take space on the motherboard and are not used after the design of the motherboard has been completed, thus have a low use rate.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views. Wherever possible, the same reference numbers are used throughout the drawings to refer to the same or like elements of an embodiment.

The figure is a block diagram of a motherboard test device including a connection module, according to an exemplary embodiment, and showing the motherboard test device connecting to external test devices through the connection module.

### DETAILED DESCRIPTION

The figure is a block diagram of a motherboard test device 100, according to an exemplary embodiment. The motherboard test device 100 includes a motherboard 11 and a connection module 12. The motherboard 11 can be a server motherboard or a personal computer motherboard, for example. The motherboard 11 includes a south bridge chip 111, a basic input output system (BIOS) chip 112, a complex programmable logic device (CPLD) chip 113, a baseboard management controller (BMC) 114, and a motherboard connector 115.

The BIOS chip 112 is used to initialize and test hardware secured on the motherboard 11 to ensure the hardware works normally. The BIOS chip 112 includes random access memory (RAM) 1121. The RAM 1121 establishes a communication with the south bridge chip 111 through an industrial standard architecture (ISA) port and stores BIOS programs, such as a self-diagnostic test program, a system bootstrap program, and an interrupt service program, for example.

The CPLD chip 113 is electronically connected to the south bridge chip 111. The BMC 114 is connected to the south bridge chip 111 through an inter-integrated circuit (I²C) bus and executes operations of powering on/off the motherboard 11, resetting the motherboard 11, monitoring a voltage of the motherboard 11, and communicating with an external system management module (SMM). The motherboard connector 115 is a high density connector and is electronically connected to the south bridge chip 111, the BIOS chip 112, the CPLD chip 113, and the BMC 114.

The connection module 12 is electronically connected to the motherboard 11 and includes a body 121, a test connector 122, a first port 123, and a second port 124. The test connector 122, the first port 123, and the second port 124 are all positioned on the body 121. The test connector 122 may be a high density connector. The connection module 12 establishes a connection with the motherboard 11 by connecting the test connector 122 to the motherboard connector 115.

Both the first and second port 123, 124 are connected to the test connector 122, thereby connecting to hardware secured on the motherboard 11, such as the RAM 1121 and the CPLD 113, for example. In detail, the first port 123 is a serial peripheral interface (SPI) and is electronically connected to the RAM 1121 through the test connector 122 and the motherboard connector 115. In this way, when the test connector 122 is inserted in the motherboard connector 115, the connection module 12 will establish connection with the motherboard 11. Then, a RAM emulator 200 can update or test BIOS programs stored in the RAM 1121 by connecting to the first port 123.

The second port 124 is a parallel program bus (PPB) port and is electronically connected to the CPLD 113 through the test connector 122 and the motherboard connector 115. In this way, when the test connector 122 is inserted in the motherboard connector 115, the connection module 12 will establish connection with the motherboard 11. Then, by connecting a parallel interface of a personal computer (PC) 300 to the second port 124 through a PPB, the PC 300 can execute operations to the CPLD 113, such as upgrades, debugs, or downloads data, for example.

In other embodiments, the connection module 12 further includes a third port 125 and a fourth port 126. Both the third and fourth port 125, 126 are positioned on the body 121 and are connected to the test connector 122, thereby connecting to the other hardware secured on the motherboard 11, such as the south bridge chip 111 and the BMC 114, for example. In detail, the third port 125 may be a peripheral component interconnect (PCI) slot or an ISA slot. The third port 125 is electronically connected to the south bridge chip 111 through the test connector 122 and the motherboard connector 115. In this way, when the test connector 122 is inserted in the motherboard connector 115, the connection module 12 will establish connection with the motherboard 11. Then, by connecting a debug card 400 to the third port 125, the debug card 400 can obtain a debug code output by the BIOS chip 112 through the south bridge chip 111 and debug the motherboard 11.

The fourth port 126 may be an intelligent platform management bus (IPMB) port and is electronically connected to the BMC 114 through the test connector 122 and the motherboard connector 115. In this way, when the test connector 122 is inserted in the motherboard connector 115, the connection module 12 will establish connection with the motherboard 11. Then, by connecting a SMM 500 to the fourth port 126, the SMM 500 can monitor and manage parameters of the motherboard 11, such as a voltage or an environment temperature, for example.

In use, the test connector 122 is inserted in the motherboard connector 115, thus, the connection module 12 is electronically connected to the motherboard 11. Then, a test device can be selectively inserted in one corresponding port of the connection module 12 to test hardware secured on the motherboard 11. In detail, a RAM simulator 200 can update or test BIOS programs stored in the RAM 1121 by connecting to the first port 123. By connecting a parallel interface of a PC 300 to the second port 124 through a PPB, the PC 300 can execute operations to the CPLD 113, such as upgrades, debugs, or downloads data, for example. A debug card 400 can obtain a debug code output by the BIOS chip 112 through the south bridge chip 111 and debug the motherboard 11 by connecting to the third port 125. By connecting a SMM 500 to the fourth port 126 through an IPMB, the SMM 500 can monitor and manage parameters of the motherboard 11, such as a voltage, a temperature, for example.

In summary, in the motherboard test device of this embodiment of the disclosure, the plurality of ports for testing hardware secured on the motherboard 11 are integrated on the connection module 12. Thus, when one or more than one hardware unit on the motherboard 11 needs to be tested, only a connection between the connection module 12 and the motherboard 11 is needed to allow one test port on the connection module 12 to connect to a corresponding test device. The motherboard test device 100 and the connection module 12 thereof can be used repeatedly, which is convenient and has high efficiency.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in the matter of arrangement of parts within the principles of this disclosure to the full extent indicated by the broad general meaning of the terms in which the appended claims are expressed.

What is claimed is:

1. A connection module connected to a motherboard, the motherboard comprising a basic input output system (BIOS) chip, a complex programmable logic device (CPLD) chip, and a motherboard connector connected to the BIOS chip and the CPLD chip; the connection module comprising:
a test connector connected to the motherboard connector;
a first port connected to random access memory (RAM) of the BIOS chip through the test connector and the motherboard connector; and
a second port connected to the CPLD chip through the test connector and the motherboard connector;
wherein a RAM simulator updates or tests BIOS programs stored in the RAM by connecting to the first port, and wherein a personal computer (PC) can electronically communicate with the CPLD chip by connecting a parallel interface of the PC to the second port.

2. The connection module of claim 1, wherein both the motherboard connector and the test connector are high density connectors.

3. The connection module of claim 1, wherein the first port is a serial peripheral interface.

4. The connection module of claim 1, wherein the second port is a parallel program bus port.

5. The connection module of claim 1, wherein the PC upgrades, debugs, or downloads data to the CPLD chip via the electronic connection.

6. The connection module of claim 1, further comprising a third port, wherein the motherboard comprises a south bridge chip connected to the BIOS chip; the third port is connected to the south bridge chip through the test connector and the motherboard connector, by connecting to the third port, a debug card obtains debug code output by the BIOS chip through the south bridge chip and debugs the motherboard.

7. The connection module of claim 6, wherein the third port is a peripheral component interconnect slot or an industrial standard architecture slot.

8. The connection module of claim 6, further comprising a fourth port, wherein the motherboard comprises a baseboard management controller (BMC); the fourth port is connected to the BMC through the test connector and the motherboard connector, a system management module monitors and manages the motherboard by connecting to the fourth port.

9. The connection module of claim 8, wherein the fourth port is an intelligent platform management bus port.

10. The connection module of claim 8, further comprising a body, wherein the test connector, the first to fourth ports are all positioned on the body.

11. A motherboard test device, comprising:
a motherboard, comprising:
a basic input output system (BIOS) chip, the BIOS chip comprising random access memory (RAM) storing BIOS programs;
a complex programmable logic device (CPLD) chip; and
a motherboard connector connected to the BIOS chip and the CPLD chip;
a connection module, comprising:
a test connector connected to the motherboard connector;
a first port connected to the RAM through the test connector and the motherboard connector; and
a second port connected to the CPLD chip through the test connector and the motherboard connector;
wherein a RAM simulator updates or tests BIOS programs stored in the RAM by connecting to the first port; and wherein a personal computer (PC) can electronically communicate with the CPLD chip by connecting a parallel interface of the PC to the second port.

12. The motherboard test device of claim 11, wherein both the motherboard connector and the test connector are high density connectors.

13. The motherboard test device of claim 11, wherein the first port is a serial peripheral interface.

14. The motherboard test device of claim 11, wherein the second port is a parallel program bus port.

15. The motherboard test device of claim 11, wherein the PC upgrades, debugs, or downloads data to the CPLD chip via the electronic connection.

16. The motherboard test device of claim 11, further comprising a south bridge chip connected to the BIOS chip, wherein the connection module further comprises a third port; the third port is connected to the south bridge chip through the test connector and the motherboard connector, by connecting to the third port, a debug card obtains debug code output by the BIOS chip through the south bridge chip and debugs the motherboard.

17. The motherboard test device of claim 16, wherein the third port is a peripheral component interconnect slot or an industrial standard architecture slot.

18. The motherboard test device of claim 16, further comprising a baseboard management controller (BMC), wherein the connection module further comprises a fourth port; the fourth port is connected to the BMC through the test connector and the motherboard connector, a system management module monitors and manages the motherboard by connecting to the fourth port.

19. The motherboard test device of claim 18, wherein the fourth port is an intelligent platform management bus port.

20. The motherboard test device of claim 18, wherein the connection module further comprises a body, the test connector, the first to fourth ports are all positioned on the body.
